(19) United States
(12) Patent Application Publication
(10) Pub. No.: US 2014/0340474 A1
(43) Pub. Date: Nov. 20, 2014

(54) PANORAMIC IMAGE SCANNING DEVICE USING MULTIPLE ROTATING CAMERAS AND ONE SCANNING MIRROR WITH MULTIPLE SURFACES

(71) Applicant: Logos Technologies LLC, Fairfax, VA (US)

(72) Inventors: David Fields, Burke, VA (US); Murray Dunn, Encinitas, CA (US)

(21) Appl. No.: 14/366,106

(22) PCT Filed: Jan. 11, 2013
(86) PCT No.: PCT/US13/21229

§ 371 Date: Jun. 17, 2014

Related U.S. Application Data
(60) Provisional application No. 61/586,445, filed on Jan. 13, 2012.

(51) Int. Cl. H04N 5/232; H04N 5/225

(52) U.S. Cl. CPC H04N 5/23238; H04N 5/2254
USPC 348/37

(57) ABSTRACT

A scanning imaging apparatus including a rotatable support platform, a first imaging device that is attached to the support platform forming a first optical path, a second imaging device that is attached to the support platform forming a second optical path, a mirror having a first reflective surface and a second reflective surface opposite to the first reflective surface, the mirror rotatably attached to the support platform and configured to deflect the first optical path with the first reflective surface, and to deflect the second optical path with the second reflective surface, a first motor configured to continuously rotate the rotatable support platform at a first angular velocity, and a second motor configured to change an angle of the mirror relative to a first optical axis and a second optical axis formed by the first and second imaging devices.

### FIELD OF THE INVENTION

The present invention relates generally to an optical scanning device that uses a scanning mirror having a front and a rear reflecting surface for two different optical paths.

### BACKGROUND OF THE INVENTION

In imaging surveillance systems, usually high resolution images are generated from a 360° scenery by rotating a camera with an image sensor by a motor, and by using a scanning mirror for each camera, and at the same time capturing images during the rotation from different view angles from the scenery. These individual images can be merged together to form a high-resolution panoramic image of the scenery. However, such conventional scanner systems require many optical elements in particular if multiple cameras are used for different purposes on the same rotating platform, and a geometric relationship between the elements has to be preserved. For example, an image surveillance system that is operable for night and daylight conditions, usually two different optical scanners use two separate and distinct scanning mirrors.

### SUMMARY OF THE EMBODIMENTS OF THE INVENTION

One of the aspects of the present invention provides for a scanning imaging apparatus. The scanning imaging apparatus preferably includes a rotatable support platform, a first imaging device that is attached to the support platform forming a first optical path, and a second imaging device that is attached to the support platform forming a second optical path. Moreover, the scanning imaging apparatus preferably further includes a mirror having a first reflective surface and a second reflective surface opposite to the first reflective surface, the mirror rotatably attached to the support platform and configured to deflect the first optical path with the first reflective surface, and to deflect the second optical path with the second reflective surface, a first motor configured to continuously rotate the rotatable support platform at a first angular velocity, and a second motor configured to change an angle of the mirror relative to a first optical axis and a second optical axis formed by the first and second imaging devices to counter-rotate against the rotation of the rotatable support platform during image integration of images with image sensors of the first and second imaging devices.

Moreover, according to another aspect of the present invention, a surveillance device is provided that is capable of generating panoramic images. The surveillance device preferably includes a rotatable support structure rotatable about a first rotational axis, a first imaging device that is attached to the support structure having a first field of view; and a second imaging device that is attached to the support structure having a second field of view. Moreover, the surveillance device also preferably includes a mirror rotatably attached to the support structure rotatable about a second rotational axis, and configured to redirect the first field of view with a first reflective surface and to redirect the second field of view with a second reflective surface, a first motor configured to continuously rotate the rotatable support structure at a first angular velocity around the first rotational axis; and a second motor configured to turn the mirror around the second rotational axis to change an angle formed by a plane defined by the first reflective surface and the first field of view so as to stabilize the first field of view and the second field of view during image acquisition of the first and second imaging devices.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1A is a diagrammatic schematic top view of a rotating optical assembly having a scanning mirror and two imaging devices, according to the first embodiment;

FIG. 1B is a diagrammatic schematic front view of a rotating optical assembly having a scanning mirror and two imaging devices, according to the first embodiment;

FIGS. 2A-2B are a schematic top views of the rotating optical assembly at two different positions during rotation according to the first embodiment;

FIG. 3 is a side view of a mirror according to the first embodiment; and

FIG. 4 is a diagrammatic schematic front view of a rotating optical assembly having a scanning mirror and two imaging devices, according to a second embodiment;

FIG. 5A is a diagrammatic schematic top view of a rotating optical assembly having a scanning mirror and three imaging devices according to a third embodiment;

FIG. 5B is a diagrammatic schematic front view of a rotating optical assembly having a scanning mirror and three imaging devices according to the third embodiment; and

FIG. 6 is a schematic representation of a control system for implementing a control method for the invention.

Herein, identical reference numerals are used, where possible, to designate identical elements that are common to the figures. Also, the images in the drawings are simplified for illustration purposes and may not be depicted to scale.

### DETAILED DESCRIPTION OF THE PREFERRED EMBODIMENTS

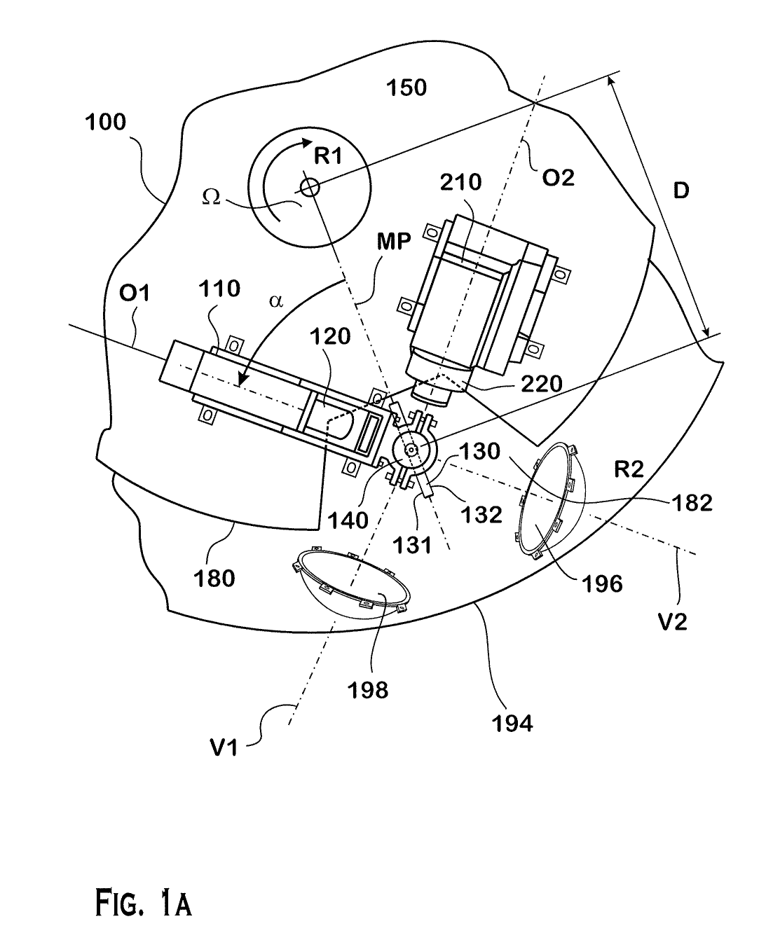

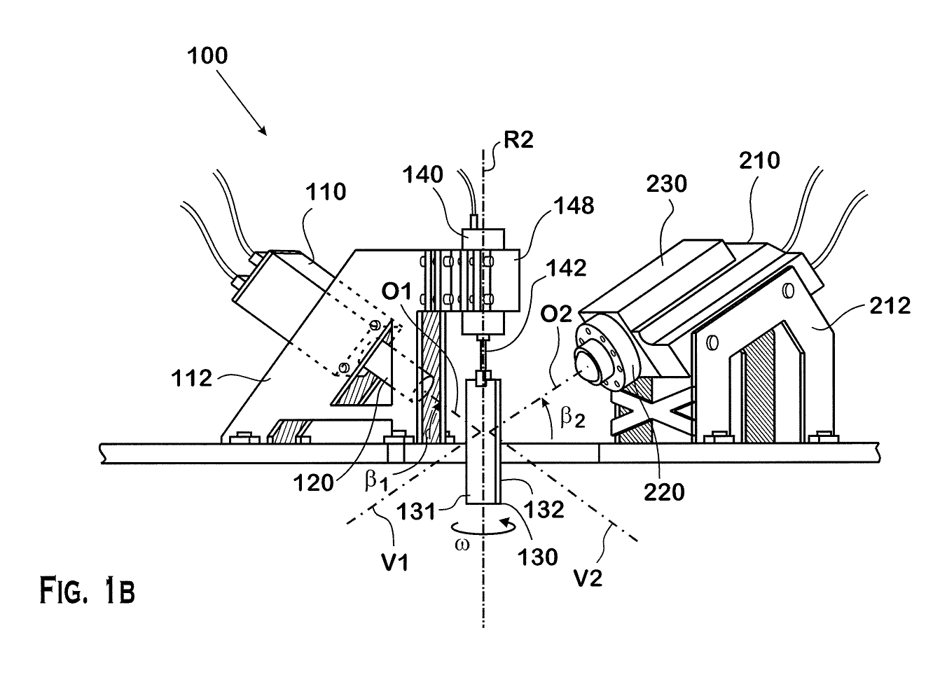

FIG. 1 depicts a diagrammatical schematic side view of a rotating optical assembly 100 having a first imaging device 110 with lens 120 that form an optical axis O1 mounted to a rotating platform 180, and a second imaging device 210 with optics 220 forming an optical axis O2 mounted to the same rotating platform 180. Rotating platform rotates about rotational axis R1 driven by a first motor 150. First motor 150 usually rotates with a rotational speed Ω, so that the first and second imaging devices 110 and 210 can capture multiple images along one rotation of disk 180. For example, if the image capture frequency of imaging devices 110 and 210 is 50 Hz, and the rotational speed or angular velocity Ω is 1 Hz, 50 images will be captured along a viewed scene after a full 360° rotation for each imaging device 110, 210.

In the variant shown, the first and second imaging device 110, 210 are oriented perpendicularly towards each other seen from above, and are inclined with an elevation angle β₁ and β₂ that are substantially the same (See FIG. 1B). Also, first imaging device 110 is a camera 110 with a two-dimensional image sensor such as a charge coupled device (CCD) or a complementary metal-oxide semiconductor (CMOS), and second imaging device 210 is an infrared camera for thermal imaging having a focal plane array (FPA) with a thermal imaging lens 220. The second imaging device 210 can be configured to capture thermal images in the near-infrared range (NIR), the mid-wave infrared range (MWIR), or the long-wave infrared range (LWIR), depending on the application. Imaging device 110 is attached to rotating platform 180 with a mounting bracket 112, and second imaging device 210 is attached to rotating platform with bracket 212. In a variant, instead of using imaging devices 110, 210 having visible light and infrared imaging capabilities, it is also possible that first imaging device 110 has optics 120 that captures images with a wide angle of view, while the second imaging device 210 has optics 220 to capture images with a narrower angle of view.

First and second imaging devices 110 and 210 are arranged such that their optical axes O1 and O2 cross or closely cross each other at a rotational axis R2 of second motor 140. Second motor 140 has a shaft 142 and at the distal end of the shaft a scanning mirror 130 is connected thereto. The first optical path formed by first imaging device 110 is reflected off a first reflecting surface 131 of mirror 130, and the second optical path formed by second imaging device 210 is reflected off a second reflecting surface 132 of the same mirror 130. Thereby, the same mirror 130 is used for both the first and second imaging devices 110, 210 for the scanning.

The first optical path of the first imaging device 110 is reflected by first surface 131 of mirror 130 such that it traverses a window 198 of an outer protective shell 194 of the rotating optical assembly 100. Scanning mirror 130 is located in an area of an opening 182 of rotatable platform, and opening 182 also allows the first and second optical paths be reflected towards respective windows 198, 196. Window 198 may be equipped of a glass or other transparent material that has filtering characteristics that provide the required light for imaging device 110, for example a filter that can only be traversed by visible light. As an example, window 198 for the visible light channel may be made of fused silica with an anti-reflection coating and a protected TiO2 coating.

Analogously, the second optical path of the second imaging device 210 is reflected by second surface 132 of mirror 130 such that it traverses window 196 of outer protective shell 194. Window 196 may be equipped of a glass or other transparent material that has filtering characteristics that provide the required radiation for imaging device 110, for example a filter that can only by passed by thermal radiation having a wavelength range in the MWIR range from 3 μm to 5 μm or a wavelength range in the LWIR range from 7 μm to 14 μm. Also, an external surface of window 196 has an anti-reflective coating. The size of windows 198, 196 is chosen such that they are wide enough not to obstruct the scanning field of view of the respective imaging device 110, 210, when the fields of view of imaging devices 110. 210 are moved by scanning mirror 130 from a maximal to a minimal angular position.

As shown in FIGS. 1A and 1B, second motor 140 is attached to rotatable platform 180 by a holding clamp 148 via bracket 112 that is holding imaging device 110. Moreover, scanning mirror 130 is made of a rigid substrate with both the first and the second surface 131, 132 being reflective. Imaging device 110 is fastened via attachment screws to side walls of bracket 112, and front walls of bracket 112 are arranged such that lens 120 is located therebetween, forming a triangular support structure. This arrangement allows to establish a rigid fixation and preserve the geometric relationship between imaging device 110, lens 120, second motor 140, and scanning mirror 130, even when rotatably optical assembly is subject to strong accelerations and vibrations. Second motor 140 has a rotational axis R2 that is parallel to the rotational axis R1, but located at radius D from the rotational axis R1 of rotatable platform 180.

Moreover, second motor 140 is configured to change an angular position of a scanning mirror 130 by rotating about an angular velocity ω while rotatable platform 180 is rotated by first motor 150 by angular velocity Ω. With the rotation of rotatable platform 180 with angular velocity Ω by first motor 150, and a counter-rotation that is performed by second motor 140 of scanning mirror 130 at am angular velocity ω, it is possible to stabilize both the viewpoints of first imaging device 110 with the first reflective surface 131 and second imaging device with the second reflective surface 132. Thereby, during image acquisition of both the first and the second imaging device 110 and 210, the resulting viewing directions V1 and V2 are stabilized. While rotatable platform 180 rotates a full turn around 360°, imaging device 110 can capture a series of visible light images of a panoramic scene viewed from a defined elevation angle β₁, and at the same time, imaging device 210 can capture a series of infrared thermal images from the same scene viewed from a define elevation angle β₂. Therefore, the frame rate of imaging devices 110, 210 is substantially faster than the angular velocity Ω. For example, if platform 180 makes full rotation 3 times per second, and the frame rate of imaging devices 110, 210 is 50 Hz, 150 images will be taken with a 360° turn. These series of images can later be processed to generate a full 360° panoramic or scenic image by image processing algorithms

While the first motor 150 usually rotates one way, for example a continuous clockwise rotation around rotational axis R1 as shown in FIG. 1A, second motor 140 can rotate back and forth, clockwise and counter-clockwise, around rotational axis R2. Also, second motor 140 does not have to perform full rotations, but has to be able to change the angular position of scanning mirror 130 relative to disk 180 to cover a certain angular range to stabilize the fields of view of imaging devices 110 and 210, for example by the use of a stepper motor with DC brushless technology. For example, the relative angular position α that is defined by a plane MP formed by an extension of the scanning mirror 130 surface, and the optical axis O1 of camera 110 and lens 120 needs to be variable by adjusting this angle with the second motor 140. Therefore, for descriptive purposes, optical axis O1 of camera 110 that is rotating can be said to form an axis of a rotating coordinate system with respect to the definition of relative angular position α of mirror 130.

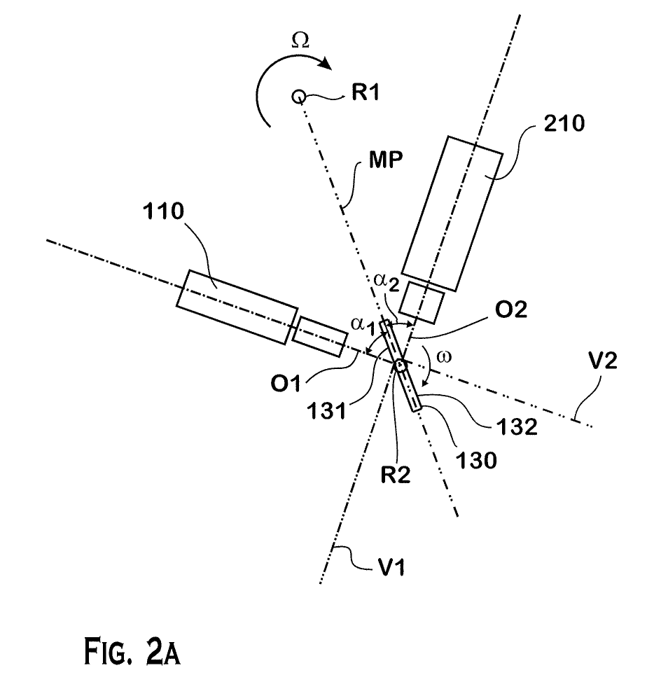

As shown with respect to FIGS. 2A and 2B, imaging devices 110 and 210 are shown with their respective optical axes O1 and O2 oriented perpendicularly towards in an exemplary arrangement. Moreover, scanning mirror 130 is arranged axisymmetrically towards both imaging devices 110, 210 actuated by second motor 140, with a relative angular position α₁ towards optical axis O1 and relative angular position α₂ towards optical axis O2. Mirror 130 is actuated so as to compensate for the rotation of imaging devices 110, 210 that is caused by the rotating platform 180 rotated by first motor 150, at least of during a time period in which both image sensors of imaging devices 110 and 210 are integrating photons in pixels to capture an image. Therefore, the rotational axes R1 of first motor 150 and R2 of second motor 140 are substantially parallel, and during image capture of at least one of imaging devices 110 and 210, second motor 140 rotates mirror 130 counter the rotation of first motor 150 at substantially the same rotational speed. This counter-rotation during image capture allows to stabilize the reflected the first and the second optical axis O1 and O2 to be oriented towards view directions V1 and V2, respectively, to stabilize the fields of view indicated by V1 and V2, irrespective of rotation Ω of both imaging devices 110, 210. In light of the integration of photons in pixels of image sensors, the temporary stabilization of fields of view V1 and V2 will substantially reduce or eliminate motion blur. In FIGS. 2A and 2B is can be seen that view directions V1 and V2 point to the same direction while imaging devices 110, 210 have been rotated in clockwise direction about 30° about rotational axis R1. Next, before the next image is captured, scanning mirror 130 is repositioned by second motor 140 to direct the first and second optical axis O1 and O2 towards a new view directions V1 and V2 by returning the angular position a of scanning mirror 130 back to the initial position before counter-rotating the mirror 130 again for image capture of the next image. This movement of scanning mirror 130 is repeated for each capturing of a subsequent image along the scene to minimize motion blur on the image that would result from rotation Ω of camera 110 during image capture. Consecutively captured images may be entirely separate from each other, may be bordering each other closely, or may also overlap, depending on rotational speed Ω, image capturing frequency of imaging devices 110, 210, and the field of view formed by optics 120, 220 and geometry of the assembly 100.

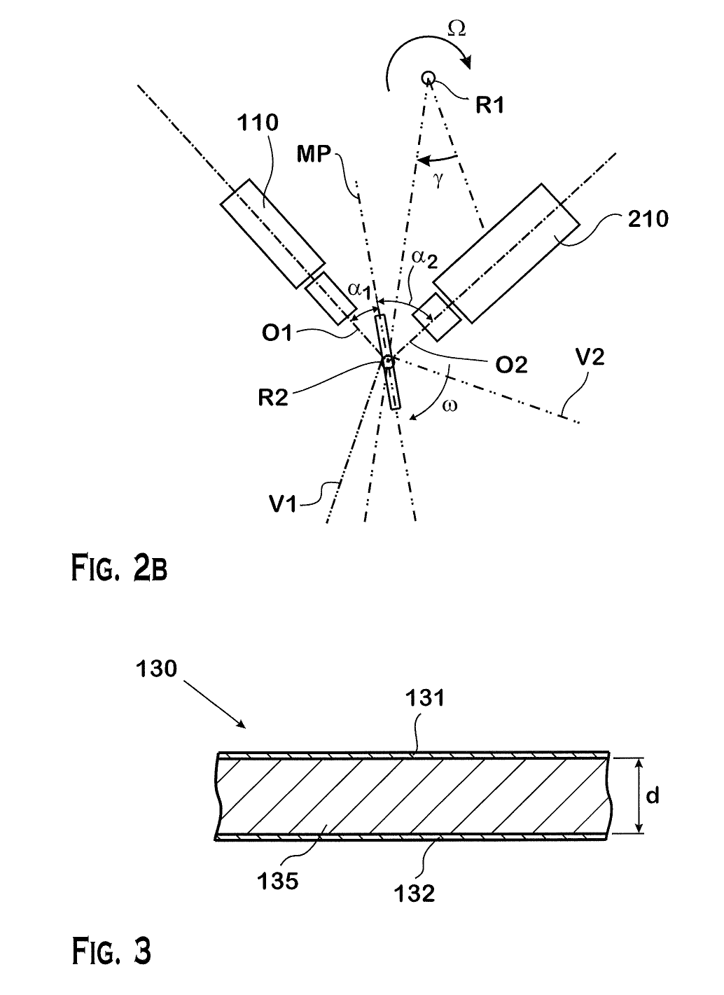

FIG. 3 shows a cross-sectional view of mirror 130 that is made of a thickness d in a range between 5 and 15 mm for stiffness purposes. Mirror 130 is made of a silicon substrate 135 that is coated on both sides with a highly reflective film, forming a first reflective surface 131 and a second reflective surface 132. Preferably, the mirror is made of a protected aluminum coating having 1/10λ surface characteristics, on a silicon substrate. In a variant, substrate 135 of mirror can be made of fused silica, beryllium, or silicon-carbide, and it is also possible that different coatings are used for the visible light and the infrared light, for example a dielectric coating for the respective wavelength band.

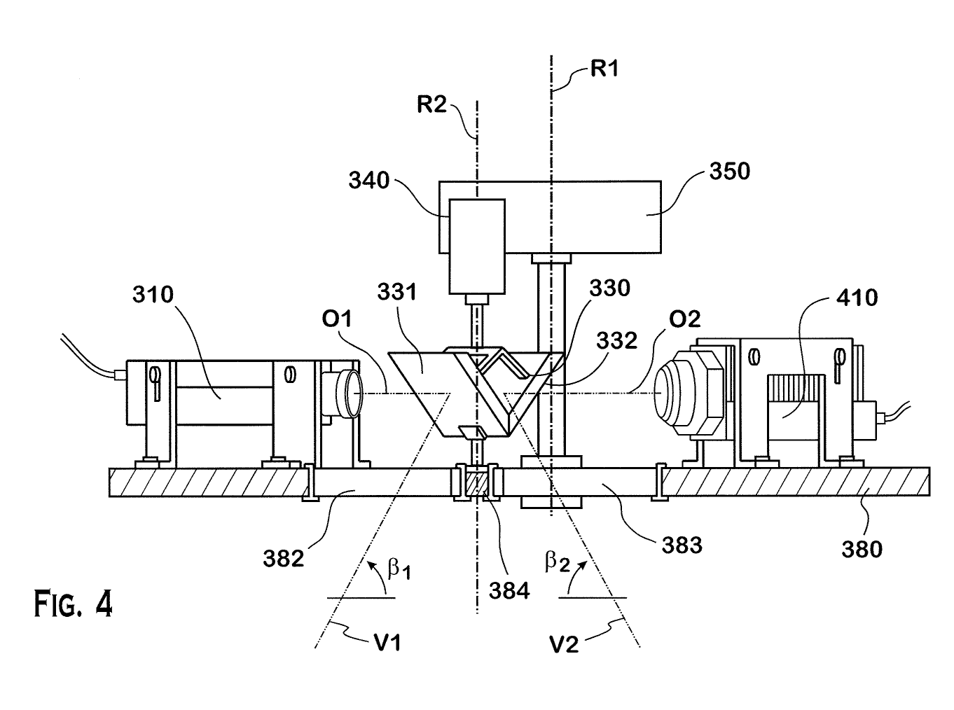

FIG. 4 shows an alternative embodiment in which imaging devices 310, 410 are arranged having optical axes O1 and O2 in a horizontal plane, for applications that require low depth. Mirror 130 has a triangular shape with the first and the second surfaces inclined by angle β₁ for the first reflective surface 331 for the first optical axis O1, and β₂ for the second reflective surface 332 for optical axis O2. Rotatable platform 380 is formed such that there are two openings 382 and 383 for view directions V1 and V2. These openings can also be equipped with windows having certain filtering characteristics. Rotational axis R1 that is formed by first motor 350 and rotational axis R2 that is formed by second motor 340 are arranged to be substantially in parallel to each other, at different locations, but it is also possible that rotational axis R1 and R2 coincide with each other. In the variant shown, elevation angle β₁ and β₂ are the same, but it is also possible that these angles are different in a case imaging device 310 and 410 would be configured to scan different panoramic scenes.

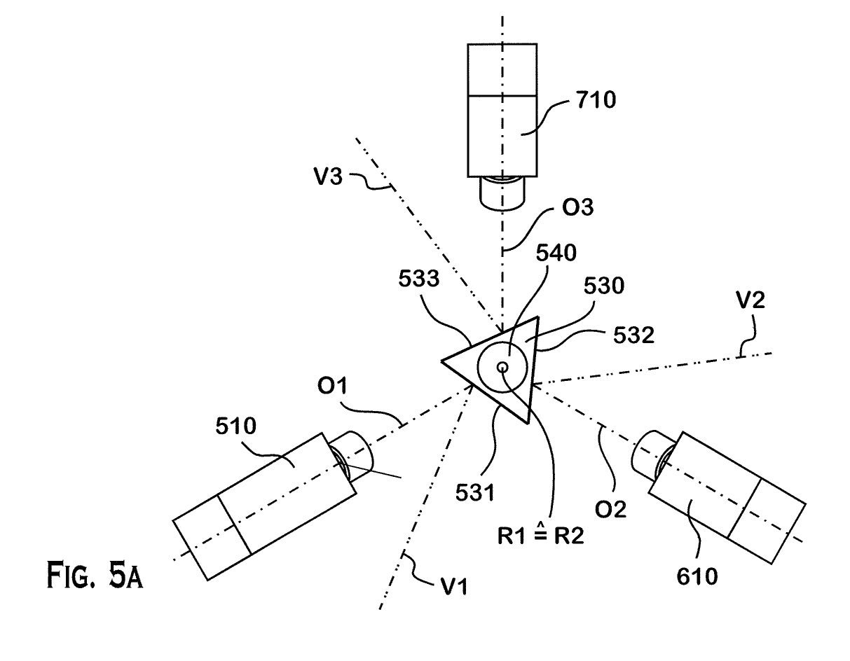

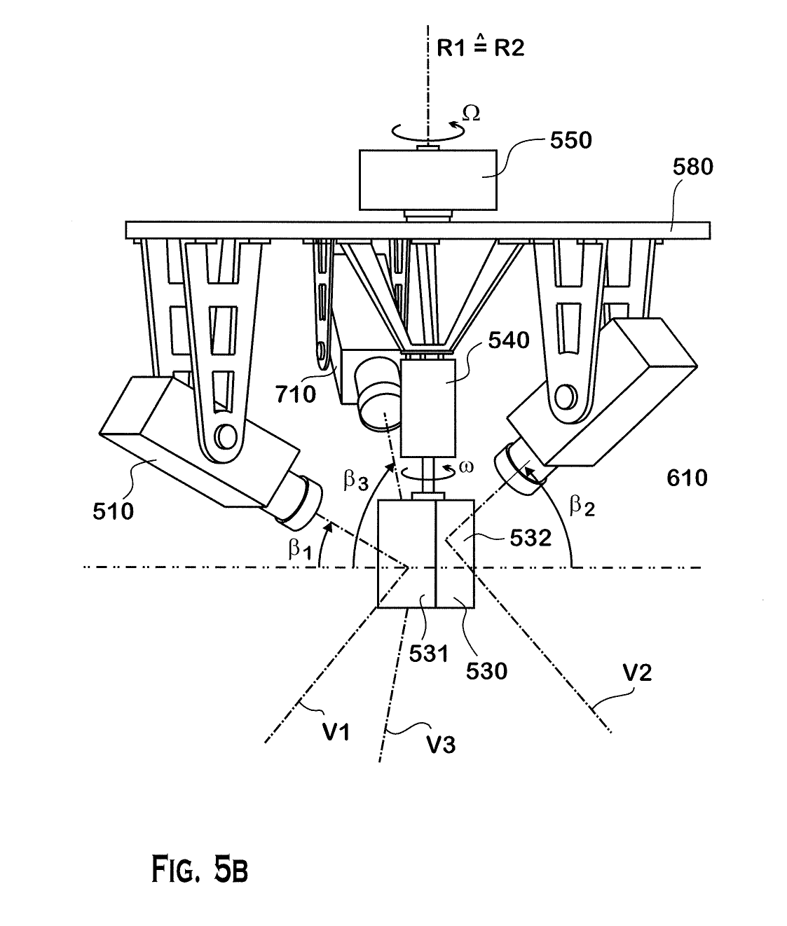

FIGS. 5A and 5B show another embodiment of the present invention, where rotational axis R1 and R2 coincide with each other, and three imaging devices 510, 610, and 710 are arranged concentrically towards each other every 120° angle. The optical axes O1, O2, and O3 of respective imaging devices 510, 610, and 710 are all reflected by a triangular mirror having first reflective surface 531 to reflect optical axis O1 and thereby forming view direction V1, second reflective surface 532 to reflect optical axis O2 and thereby forming view direction V2, and third reflective surface 533 to reflect optical axis O3 and thereby forming view direction V3. As seen in FIG. 5B, imaging devices 510, 610, and 710 are the same but have different elevation angles β₁, β₂, and β₃. This configuration allows to scan three different panoramic scenes by the three different, imaging devices 510, 610, and 710. First motor 550 rotates disk 580 about rotational axis R1, and since the rotational axis of second motor 540 coincides with rotational axis R1, second motor 540 can actuate triangular mirror 530 about the same rotational axis with angular velocity ω. This embodiment is particularly advantages for fast scanning rotations with angular velocity Ω around rotational axis R1 in light of the substantially symmetric weight distribution. Other configurations are also with the scope of this embodiment, where more that three imaging devices are used, with a mirror element that has a corresponding number of reflective surfaces. Also, imaging devices 510, 610, and 710 can also be oriented to have their optical axes O1, O2, and O3 in a horizontal plane, and the inclination angles β₁, β₂, and β₃ are given by scanning mirror 530 that has slanted surfaces, as shown with respect to FIG. 4.

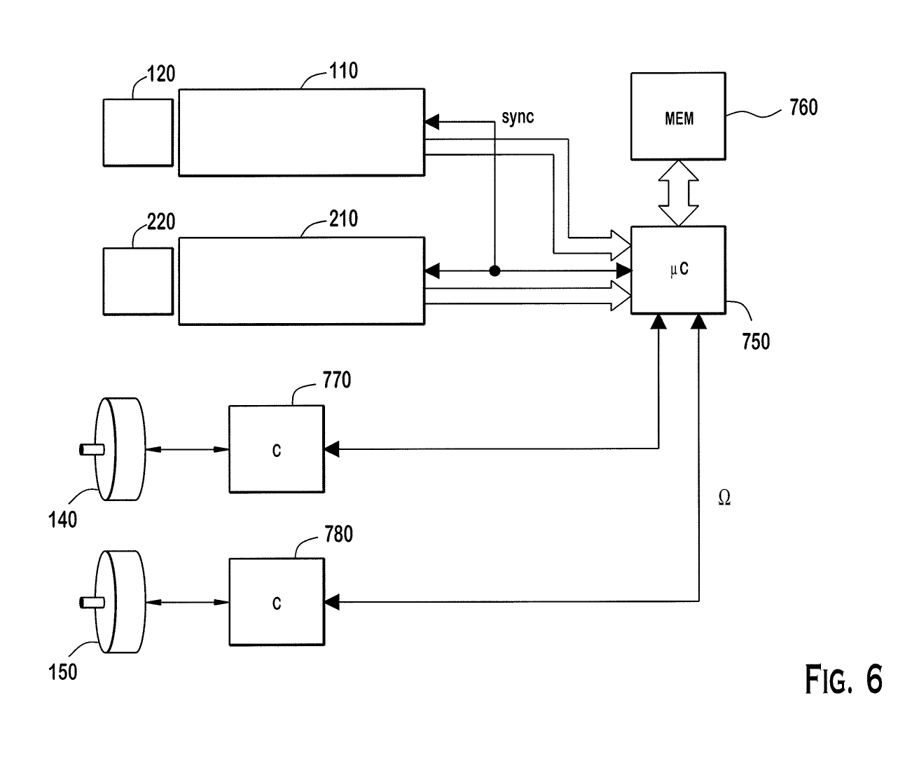

FIG. 6 is a schematic representation of a control system to control image capturing by the first imaging device 110, the second imaging device 210, and the control of second motor 140 to counter-rotate against rotational speed Ω by first motor 150 during a time when an image is integrated by image sensors of both the first and second imaging device 110, 210. A central controlling device 750 is used to synchronize a time of image capturing with both the first and second imaging device 110, 210 to be in sync with the counter-rotating of scanning mirror 130 that is controlled by motor controller 770. Motor controller 780 of second motor delivers the rotational speed Ω to controlling device 750, so that the angular velocity Ω of counter-rotation of mirror 130 can be properly set. Controlling device 750 may also have access to memory for storing captured image data, but also to store look-up tables that include timing values for image capturing synchronization, and waveforms as a function of time to control relative angular position α₁ and α₂. It is not necessary that both first and second imaging device 110, 210 capture the images exactly at the same time, and the integration times of each camera can be somewhat different, as long as both images are captured during the same time period in which mirror 130 is performing the counter-rotation to rotational speed Ω of motor 150.

While the invention has been described with respect to specific embodiments for complete and clear disclosures, the appended claims are not to be thus limited but are to be construed as embodying all modifications and alternative constructions that may occur to one of ordinary skill in the art which fairly fall within the basic teachings here set forth.

1. A scanning imaging apparatus comprising:
a rotatable support platform;
a first imaging device that is attached to the support platform forming a first optical path;
a second imaging device that is attached to the support platform forming a second optical path;
a mirror having a first reflective surface and a second reflective surface opposite to the first reflective surface, the mirror rotatably attached to the support platform and configured to deflect the first optical path with the first reflective surface, and to deflect the second optical path with the second reflective surface;
a first motor configured to continuously rotate the rotatable support platform at a first angular velocity; and
a second motor configured to change an angle of the mirror relative to a first optical axis and a second optical axis formed by the first and second imaging devices to counter-rotate against the rotation of the rotatable support platform during image integration of images with image sensors of the first and second imaging devices.

2. A surveillance device that is capable of generating panoramic images, comprising:
a rotatable support structure rotatable about a first rotational axis;
a first imaging device that is attached to the support structure having a first field of view;
a second imaging device that is attached to the support structure having a second field of view;
a mirror rotatably attached to the support structure rotatable about a second rotational axis, and configured to redirect the first field of view with a first reflective surface and to redirect the second field of view with a second reflective surface;
a first motor configured to continuously rotate the rotatable support structure at a first angular velocity around the first rotational axis; and
a second motor configured to turn the mirror around the second rotational axis to change an angle formed by a plane defined by the first reflective surface and the first field of view so as to stabilize the first field of view and the second field of view during image acquisition of the first and second imaging devices.
